(19) United States
(12) Patent Application Publication
(10) Pub. No.: US 2004/0011098 A1
(43) Pub. Date: Jan. 22, 2004

(54) Compound locking device

(76) Inventor: Ping-Jan Yang, Taipei (TW)

Correspondence Address: PING-JAN YANG, P.O. BOX 26-757, TAIPEI, TW

(21) Appl. No.: 10/199,625

(22) Filed: Jul. 17, 2002

(51) Int. Cl. E05B 37/00

(52) U.S. Cl. 70/284; 70/285

(57) ABSTRACT

A compound locking device is provided. The compound locking device includes a key locking mechanism comprising a outer cylinder and a lock head sleeved by the outer cylinder;a positioning plate capable of restraining the outer cylinder from rotating;a combination locking mechanism comprising the positioning plate, wherein the positioning plate is adjusted to a predetermined position by means of inputting a set of correct numbers, thereby rendering the outer cylinder rotatable; and reset member protruding from near a key hole of the key locking mechanism, wherein the reset member can change the code of the combination locking mechanism.

### BACKGROUND OF THE INVENTION

1. Field of the Invention

The present invention relates to a compound locking device, and more particularly, to a lock assembly consisting of a key locking combined with a combination locking mechanism.

2. Description of the Prior Art

Compound locking device is known in the art. The prior art locking device comprises a body 1a with a combination locking mechanism therein.

The prior art locking device further comprises a key locking mechanism. One end of a shaft of the combination locking mechanism is inserted into the key locking mechanism and is connected to a cylinder core. However, as known in the field, the cylinder core of the key locking mechanism is made according to and only suited for one particular type of the combination locking mechanism. This causes a high manufacturing cost. Further, the prior art has complicated structure and cannot be assembled easily. It is therefore attempted by the applicant to deal with the above situation encountered by the prior art.

### SUMMARY OF THE INVENTION

It is therefore a primary object of the present invention to provide an improved compound locking device having a combined key and second locking mechanism. One can unlock the compound locking device by using either a set of correct numbers, a proper key. The locking device according to this invention is user-friendly.

According to the claimed invention, a compound locking device, comprising a key locking mechanism comprising a outer cylinder and a lock head sleeved by the outer cylinder;a positioning plate capable of restraining the outer cylinder from rotating;a combination locking mechanism comprising the positioning plate, wherein the positioning plate is adjusted to a predetermined position by means of inputting a set of correct numbers, thereby rendering the outer cylinder rotatable; and reset member protruding from near a key hole of the key locking mechanism, wherein the reset member can change the code of the combination locking mechanism.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a perspective view of a compound locking device according one preferred embodiment of this invention.

FIG. 1A is an exploded diagram of FIG. 1 according to this invention.

FIG. 2 is a typical view of the invention.

FIG. 3 is fragmentary, exploded diagram of FIG. 1.

FIGS. 3A and 3B illustrate the use of this invention in FIG. 3.

FIG. 4 is a front view of the combined locking device of the present invention.

FIG. 5 is a cross sectional view of the combined locking device of the present invention.

FIG. 6 to FIG. 9 are cross sectional diagrams of this invention.

### DETAILED DESCRIPTION OF THE PREFERRED EMBODIMENT

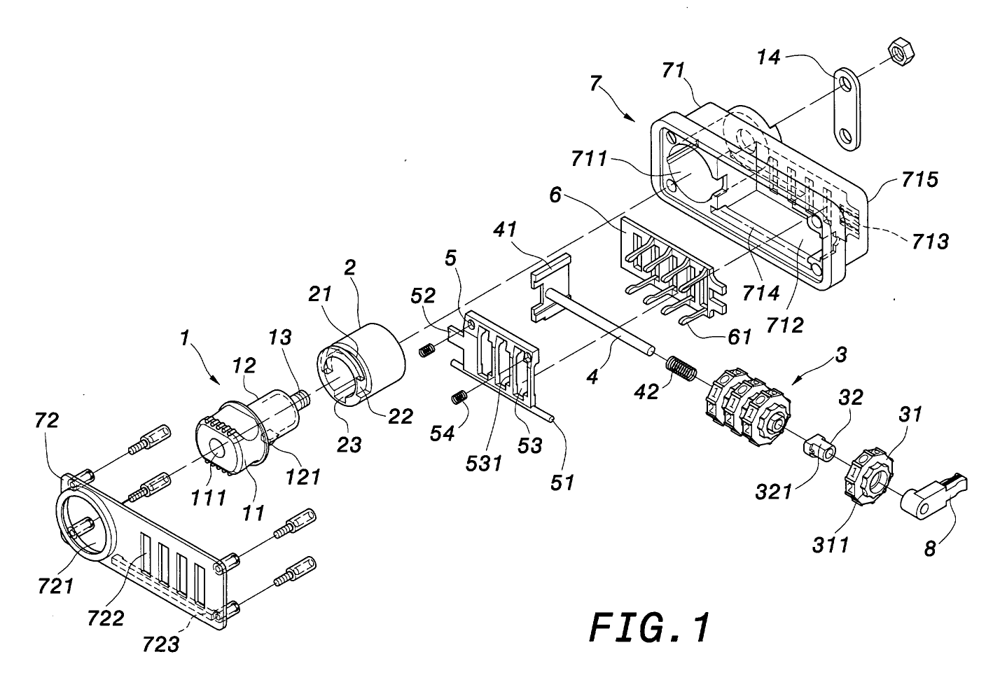

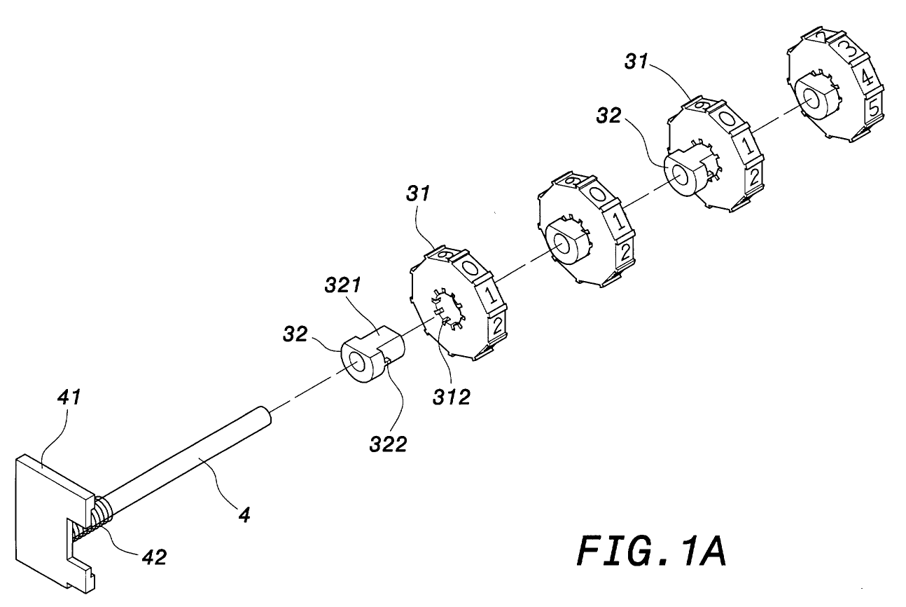

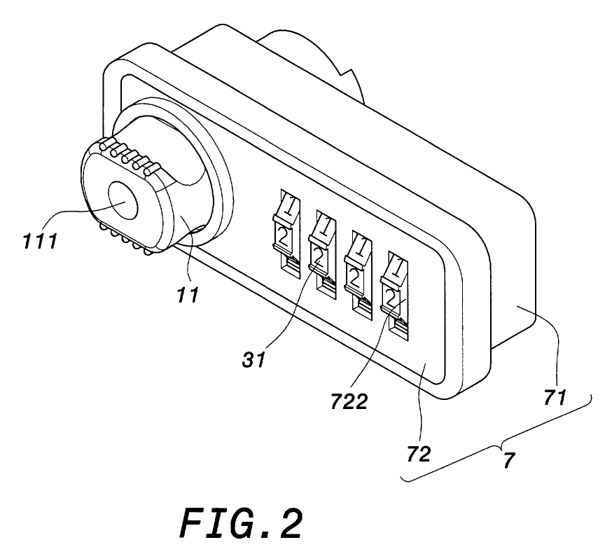

Please refer to FIG. 1 and FIG. 2. This invention is directed to an improved compound locking device. The compound locking device comprises a lock body 7 having a casing 71 and a lid 72, a key locking mechanism having a lock head 1 and an outer cylinder 2, a combination locking mechanism having a figure wheel set 3, a shaft 4 and a snapping piece 6. The compound locking device further comprises a positioning plate 5 and a reset member 8. A rear portion of the lock head 1 is connected with a latch 14.

The casing 71 has a first chamber 711 and a second chamber 712 for accommodating the above-mentioned key locking mechanism and the combination locking mechanism respectively. At the rear portion, corresponding to the first chamber 711 and second chamber 712, has an opening that allows a lock head protruding portion 13 to pass through and an aperture 713 that allows the reset member 8 to pass through respectively. An embedding slot 714 is recessed below the second chamber 712. The outer cylinder 2 of the key locking mechanism is movably sleeved in the first chamber 711. The snapping piece 6 of the combination locking mechanism is disposed in the second chamber 712. As illustrated, the snapping piece 6 comprises a plurality of pairs of symmetrically arranged snapping arms 61.

At a front end and on an outer surface of the outer cylinder 2, an outer guiding groove 21 is provided. On the interior surface of the outer cylinder 2, an axially extending inner guiding groove 23 is provided. Further, one end of the outer guiding groove 21 is connected to an axially opened positioning slot 22.

The lock head 1 comprises a holding head 11, inner cylinder 12, protrusion portion 13, and latch 14. The holding head 11 has a key hole 111. A protrusion 121 radially protrudes at a bottom of the inner cylinder 12 corresponding to the inner guiding groove 23 of the outer cylinder 2. A protruding portion 13 extends from a rear portion of the lock head 1. The lock head 1 comprises a lock core (not shown) therein. The protrusion 121 is retractable and is actuated by a key inserted into the key hole 111 to unlock the lock head 1. The inner cylinder 12 of the lock head 1 is sleeved in the outer cylinder 2. Since the protrusion 121 engages with the inner guiding groove 23 of the outer cylinder 2, the lock head 1 and the outer cylinder 2 can rotate together, unless the outer cylinder 2 is restricted by other force, as known to those skilled in the art. When assembling the inner cylinder 12 of the lock head 1 and the outer cylinder 2, the protruding portion 13 protrudes from the opening at the rear portion 715 of the casing 71 and the latch 14 is secured onto the protruding portion 13.

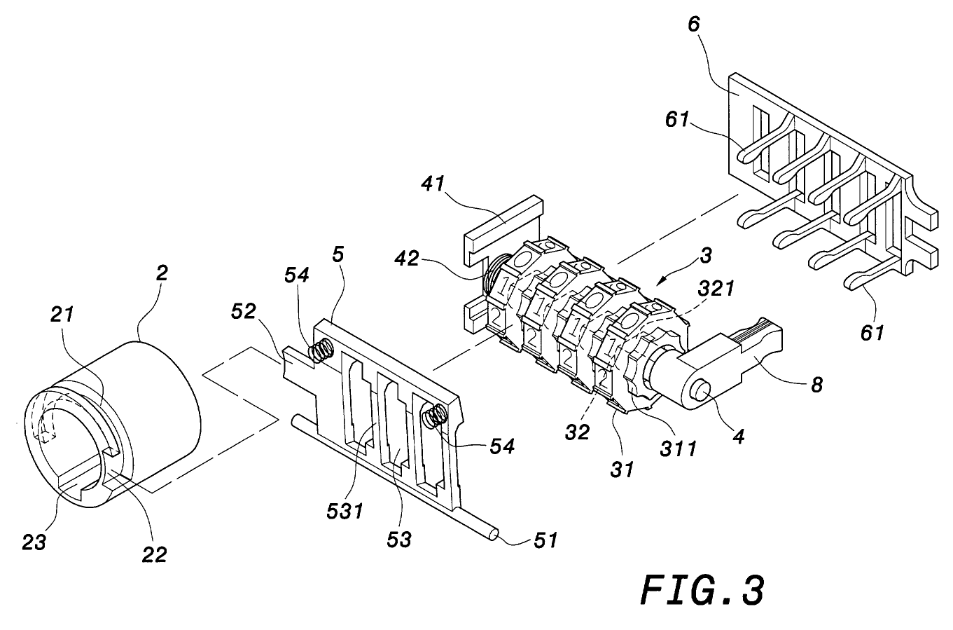

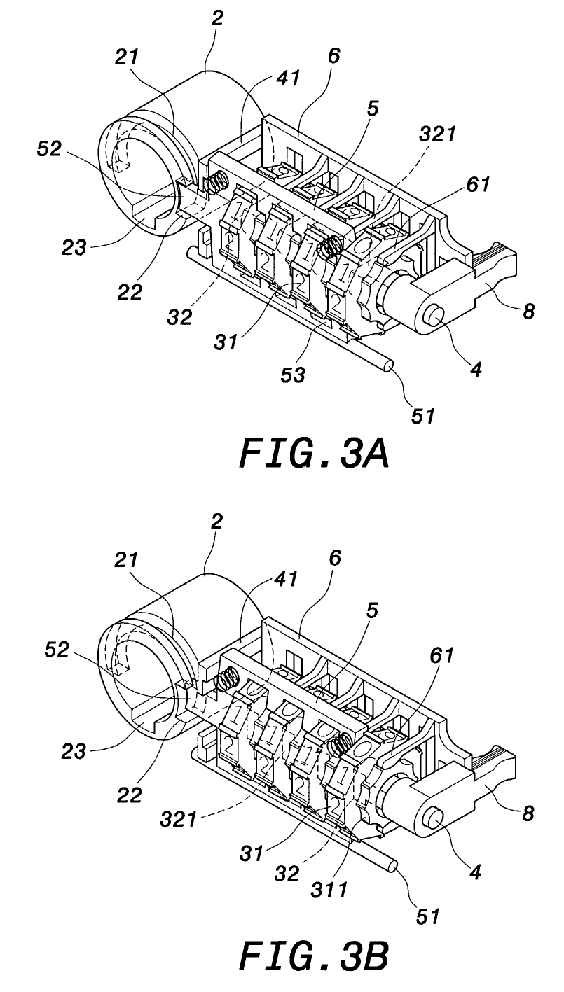

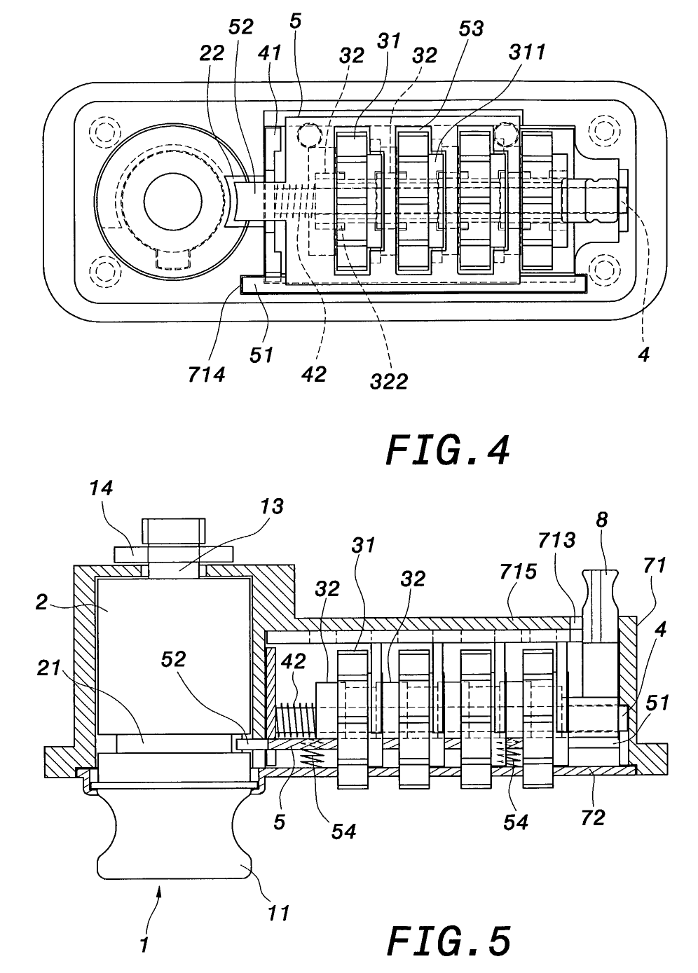

The figure wheel set 3 comprises a plurality of pairs of figure wheels 31 and positioning cam sleeves 32. Each of the figure wheels 31 has a fringe 311 at one side of the wheel 31. As best seen in FIG. 8, regularly recessed pattern is formed on the peripheral surface of the fringe 311 such that a pair of the snapping arms 61 can flexibly buckle the figure wheels 31. The positioning cam sleeve 32, which has an approximately T shaped cross section, has a surface 321. With reference to FIG. 1A, both of the figure wheel 31 and associated positioning cam sleeve 32 have a center hole that allows the shaft 4 to pass through. As such, the figure wheel 31 is pivotally connected with the positioning cam sleeve 32, the positioning cam sleeve 32 is pivotally connected with shaft 4 having a side plate 41 thereon. On the other side of the figure wheel 31 opposite to the fringe 311, a plurality of spaced damascened grooves 312 are provided. Corresponding teeth 322 are provided on the connecting portion of each of the positioning cam sleeves 32. When assembly, the teeth 322 engage with the grooves 312 such that the wheels 31 and the sleeves 32 can rotate together. As shown in FIG. 3 and FIG. 4, after assembling the figure wheel set 3, the positioning cam sleeves 32 are serially connected to each other. The left end of the serially connected positioning cam sleeves 32 is connected with the reset member 8, and the right end of the serially connected positioning cam sleeves 32 is biased with a flexible device 42, which is sleeved on the shaft 4 and is positioned between the positioning cam sleeve 32 and the side plate 41.

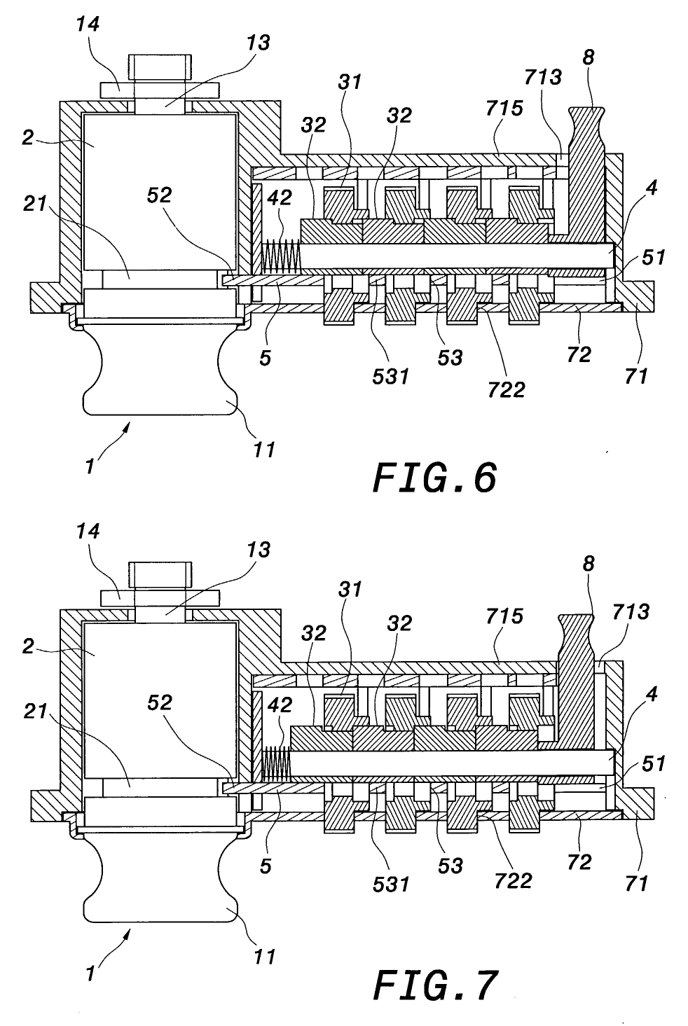

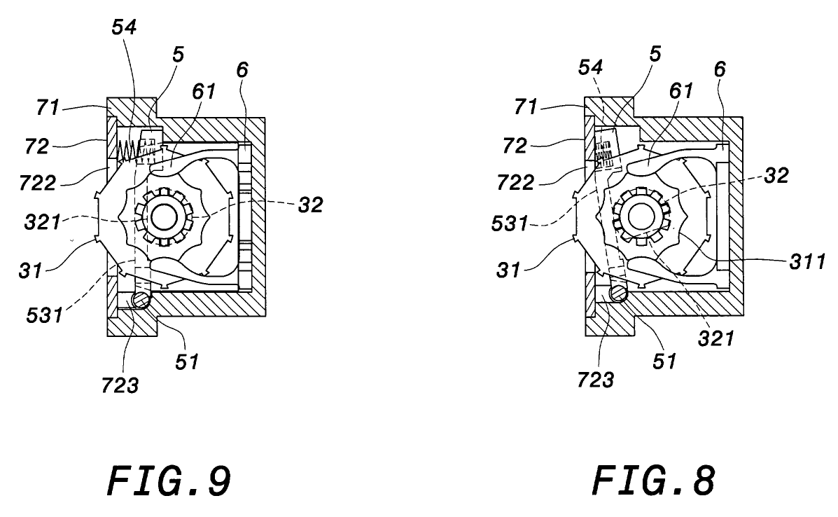

After assembling the figure wheel set 3, the shaft 4, and the reset member 8 to form a configuration as illustrated in FIG. 3, as shown in FIG. 1, FIG. 4, and FIG. 5, the combined assembly in FIG. 3 is installed in the second chamber 711 of the above-mentioned casing 71 in a manner that each pairs of the snapping arms 61 of the snapping piece 6 snap the recessed patterns of the fringes 311 (see FIG. 8). The other end of the reset member 8 protrudes from the aperture 713 and the distal free end of the shaft 4 is positioned on the right wall of the second chamber 712. The positioning plate 5 is then secured on the casing 71 to over the second chamber 712 and in a manner that a lower parallel rod 51 fits into the embedding slot 714 below the second chamber 712 and a left protruding member 52 engages with the positioning slot 22. With reference to FIG. 6, a plurality of spaced holes 53 are provided on the positioning plate 5 and each of which corresponds to each of the figure wheels 31. When assembled, the figure wheels 31 protrude through the holes 53. Further, at all times, the positioning cam sleeves 32 jab bridge portions 531 between two adjacent holes 53.

With reference to FIG. 1, the lid 721 has a through hole 721 and a plurality of spaced adjusting windows 722. When assembly, the lid 721 is screwed on the casing 71 and covers the internal elements within the casing 71. The holding head 11 of the lock head 1 protrudes through the through hole 721 and the figure wheels 31 protrudes through associated adjusting windows 722, as shown in FIG. 2. The lid 72 further comprises a lower stick 723 corresponding to the embedding slot 714 of the casing 71. When assembly, the lower stick 723 seals the lower parallel rod 51 of the positioning plate 5 in the embedding slot 714, as shown in FIG. 8 and FIG. 9. With no outer force, the positioning plate 5 is pushed to a vertical position as shown in FIG. 9.

According to the present invention, whether the outer cylinder 2 is rotatable depends on the positions of the positioning plate 5, i.e., vertical position or inclined position. As shown in FIG. 3B, the outer cylinder 2 is rotatable since the positioning plate 5 is at vertical position. As shown in FIG. 3A, the outer cylinder 2 is not rotatable since the positioning plate 5 is at inclined position. As shown in figures, when the positioning plate 5 is at inclined position, the protruding member 52 engages with the positioning slot 22 of the outer cylinder 2 and therefore restricts the outer cylinder from rotating. When the positioning plate 5 is at vertical position, the protruding member 52 disengages with the positioning slot 22 of the outer cylinder 2, instead, the protruding member 52 engages with the outer guiding groove 21 of the outer cylinder 2, such that the outer cylinder 2 can rotate according to the path defined by the guiding groove 21 and the protruding member 52.

As shown in FIG. 3B and FIG. 9, the status of the positioning plate 5 depends on that if the surface 321 of the positioning cam sleeve 32 contacts the positioning plate 5, i.e., in contact with the bridge portions 531 of the positioning plate 5. If any surface 321 does not contact the bridge portions 531, the positioning plate 5 remains in a declined status, as shown in FIG. 8. As shown in FIG. 3A, all the surfaces 321 of the positioning plate do not connect with the positioning cam sleeve 32. As shown in FIG. 8, when any of the arc shaped surface of the positioning cam sleeve 32 is connected with the positioning plate 5, the positioning plate 5 is pushed to a declined status. As shown in FIG. 9, when all of the surfaces 321 of the positioning cam sleeves 32 are connected with the positioning plate 5, the positioning plate 5 is pushed to a vertical status by means of the second flexible device 54.

If all of the surfaces 321 of the positioning cam sleeves 32 are connected with the positioning plate 5 or not depends on the operator or user gets the right combination number to unlock the device. If a set of correct number is input, all of the surfaces 321 of the positioning cam sleeves 32 are connected with the positioning plate 5, and the positioning plate 5 is pushed to a vertical status by means of the second flexible device 54. If there is one figure wheel is adjusted to a correct position according to a set of wrong number, the arc shaped surface of associated positioning cam sleeve 32 will connects with the positioning plate 5, thereby forming a declined status as illustrated in FIG. 8. When in a declined status in FIG. 8, the outer cylinder 2 cannot rotate as illustrated in FIG. 3A. According to the present invention, if one input a set of wrong numbers, he can not unlock the device through the lock head since the outer cylinder 2 is restricted.

Therefore, if the operator has the key to unlock this device, he can insert the key into the lock head so as to retract the protrusion 121 back into the lock head 1, such that the lock head 1 can rotate within the outer cylinder 2 and activate the latch 14 to rotate and unlock the device. If the operator forgets to carry the key, he can use a set of right numbers to unlock the combination locking mechanism by adjusting the positioning plate 5 to a vertical status. When the positioning plate 5 is adjusted to a vertical status, the holding head 11 of the lock head 1 is rotated and the outer cylinder 2 is also rotated by the guiding of the lock head 1, thereby rotating the latch 14.

Furthermore, if the operator needs to change the code of the combination locking mechanism, the locking device of this invention is unlocked, by unlocking either the combination locking mechanism or the key locking mechanism. As shown in FIG. 6 and FIG. 7, the reset member 8 is swayed to reset the code. With this configuration, if one forgets the code, he can unlock the locking device first and then reset the code by swaying the reset member 8. For example, in a case that the locking device of this invention is installed on a door, the operator has to unlock the locking device to open the door. After the door is opened, he can reset the code by using the reset member 8. If he does not have a key or a set of right numbers, he cannot enter the door and therefore cannot reset the code. In other words, the code cannot be changed from outside. As shown in FIG. 6 and FIG. 7, when swaying the reset member 8, all of the serially connected positioning cam sleeves 32 are pushed and shift to a left side. The figure wheels 31 are restrained by the opening 53 of the positioning plate 5 and the windows 722 of the lid, thereby leaving the positioning cam sleeves 32 apart from the associated figure wheels 31, as illustrated in FIG. 7 (or also see FIG. 1A: the second pair of the figure wheel and positioning cam sleeve from the right side). When the positioning cam sleeves 32 are apart from the associated figure wheels 31, the code can be reset. After the code is reset, the reset member 8 is released and all of the serially connected positioning cam sleeves 32 are forced to original engagement status by the first flexible device 42, as shown in FIG. 6.

From above, the applicant utilizes the positioning plate to achieve the goal of this invention. With this positioning plate, a specific key locking mechanism may be suited for any kind of combination locking mechanism. The combination of the positioning plate and the outer cylinder is able to lock or unlock the combination locking mechanism. The combination of the outer cylinder, inner cylinder, and the cylinder core is able to lock or unlock the key locking mechanism. The two locking mechanisms are operated independently. Further, the latch of this invention may be combined with the inner cylinder and has a various types. Moreover, the appearances of the body are designed in various types. Plus, the combination locking mechanism provides reset function for a user to increase security.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A compound locking device, comprising:
a key locking mechanism comprising a outer cylinder and a lock head sleeved by the outer cylinder;
a positioning plate capable of restraining the outer cylinder from rotating;
a combination locking mechanism, wherein the positioning plate is adjusted to a predetermined position by means of inputting a set of correct numbers, thereby rendering the outer cylinder rotatable; and
a reset member protruding from near a key hole of the key locking mechanism, wherein the reset member is capable of changing the code of the combination locking mechanism.

2. The compound locking device of claim 1 wherein an outer guiding groove is provided at a front end and on an outer surface of the outer cylinder, and one end of the outer guiding groove forms an axially opened positioning slot.

3. The compound locking device of claim 2 wherein the positioning plate comprises a protruding member, and the outer cylinder is not rotatable after the positioning plate is adjusted in inclined position, and the protruding member engages with outer guiding groove of the outer cylinder, so as to rotate the outer cylinder after the positioning plate is adjusted in vertical position.

4. The compound locking device of claim 3 wherein the positioning plate rotates by using a bottom side thereof as a fulcrum, wherein the key locking mechanism, combination locking mechanism and the positioning plate are installed in a lock body, and an upper position between the positioning plate and the lock body is biased with a second flexible device.

5. The compound locking device of claim 1 wherein combination locking mechanism comprises a figure wheel set comprising a plurality of serially connected figure wheels interposed with a plurality of positioning cam sleeves.

6. The compound locking device of claim 5 wherein each of the positioning cam sleeves of the figure wheel set has a plane surface, the positioning plate is adjusted in a vertical position and allow the rotation of the outer cylinder after all of the plane surfaces of the positioning cam sleeves are connected with the positioning plate, or, the positioning plate is adjusted in declined position that forbids the rotation of the outer cylinder.

7. The compound locking device of claim 5 wherein each of the figure wheels of the figure wheel set engages with an associated positioning cam sleeve, and a reset member is used to disengage each of the figure wheels of the figure wheel set with associated positioning cam sleeves, wherein a first flexible device is provided at one end of the figure wheel set serially connected positioning cam sleeves and at the other end of the figure wheel set is connected with the reset member.

8. The compound locking device of claim 7 wherein each of the positioning cam sleeves of the figure wheel set has a surface, and the positioning plate has a plurality of holes and bridge portions which located between the adjacent holes, and each of the figure wheels protrudes through the holes respectively, the positioning plate is adjusted in a vertical position and allow the rotation of the outer cylinder after all of the plane surfaces of the positioning cam sleeves are connected with the positioning plate, or, the positioning plate is adjusted in declined position that forbids the rotation of the outer cylinder.

9. The compound locking device of claim 1 wherein the outer cylinder is rotatable (not restricted by the positioning plate), and one rotates the lock head and the outer cylinder together to unlock the locking device.

10. The compound locking device of claim 1 wherein the key locking mechanism is unlocked by using a key, and one does not need to adjust a code of the combination locking mechanism.
